(19) United States
(12) Patent Application Publication
(10) Pub. No.: US 2002/0161698 A1
(43) Pub. Date: Oct. 31, 2002

(54) Caching system using timing queues based on last access times

(76) Inventor: Kelly J. Wical, St. Augustine, FL (US)

Correspondence Address: DORSEY & WHITNEY, LLP, SUITE 4700, 370 SEVENTEENTH STREET, DENVER, CO, 80202-5647, US

(21) Appl. No.: 09/790,680

(22) Filed: Feb. 23, 2001

Related U.S. Application Data
(60) Provisional application No. 60/237,611, filed on Oct. 4, 2000.

(51) Int. Cl. G06F 17/60

(52) U.S. Cl. 705/38

(57) ABSTRACT

System for managing caches containing transaction information. Queued transactions are held within a queue and transmitted in sequential order for processing. Real-time transactions, associated with the queued transactions, are posted for execution based upon determining whether the corresponding queued transactions have been posted. The system synchronizes the asynchronous posting of the queued transactions with the real-time transactions in order to ensure that the required information is present for executing the transactions.

### REFERENCE TO RELATED APPLICATIONS

The present application is related to the following applications, all of which are incorporated herein by reference as if fully set forth: United States provisional patent application of Kelly Wical, entitled “Apparatus and Method for Managing Electronic Commerce Transactions in an Automated and Distributed Replication System,” and filed on Oct. 4, 2000; United States patent application of Kelly Wical, entitled “Switched Session Management Using Local Persistence in an Automated and Distributed Replication System,” and filed on even date herewith; and United States patent application of Kelly Wical, entitled “Batch Processing System Running in Parallel on Automated and Distributed Replication Systems,” and filed on even date herewith.

### FIELD OF THE INVENTION

The present invention relates to an apparatus and method for managing electronic transactions within automated and distributed replication systems and other environments. It relates more particularly to a caching system using timing queues.

### BACKGROUND OF THE INVENTION

Systems for processing electronic transactions often include multiple levels of redundancy of servers and other machines. The redundancy means that, if one machine fails, other machines may take over processing for it. In addition, use of multiple levels of machines provides for distributing a load across many machines to enhance the speed of processing for users or others. The use of multiple levels of machines requires management of processing among them.

For example, each machine typically may have its own local cache and other stored data in memory. Management of a local cache in memory typically must be coordinated with the cache and memory of the other machines processing all of the electronic transactions. Therefore, use of multiple machines and levels requires coordination and synchronization among the machines in order to most effectively process electronic transactions without errors.

### SUMMARY OF THE INVENTION

An apparatus and method consistent with the present invention caches data using timing queues based upon access to the data. A queued transaction is received and stored within a queue for asynchronous posting, and a real-time transaction is also received for execution based upon the queued transaction. The real-time transaction is executed based upon detecting an indication of whether the queued transaction has been posted.

Another apparatus and method consistent with the present invention also caches data using timing queues based upon access to the data. A real-time transaction is received from a user, and information for the real-time transaction is stored in a local cache for posting. Last access and previous access times are recorded for the stored information, and application database and current queue posting times are detected. The real-time transaction is selectively posted and executed based upon comparing the last access time with the application database time and comparing the previous access time with the current queue posting time.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of an exemplary automated and distributed replication system for processing electronic transactions;

FIG. 2 is a diagram of exemplary components of machines in the automated and distributed replication system;

FIG. 3 is a diagram of exemplary components used in the machines for a caching system;

FIG. 4 is an example of a user screen for a user to interact with the system to enter purchases or other information;

FIG. 5 is a flow chart of a transaction and cache management routine; and

FIG. 6 is a diagram of a page for use in requesting whether a user wants to wait for execution of a real-time transaction.

### DETAILED DESCRIPTION

### Automated and Distributed Replication System

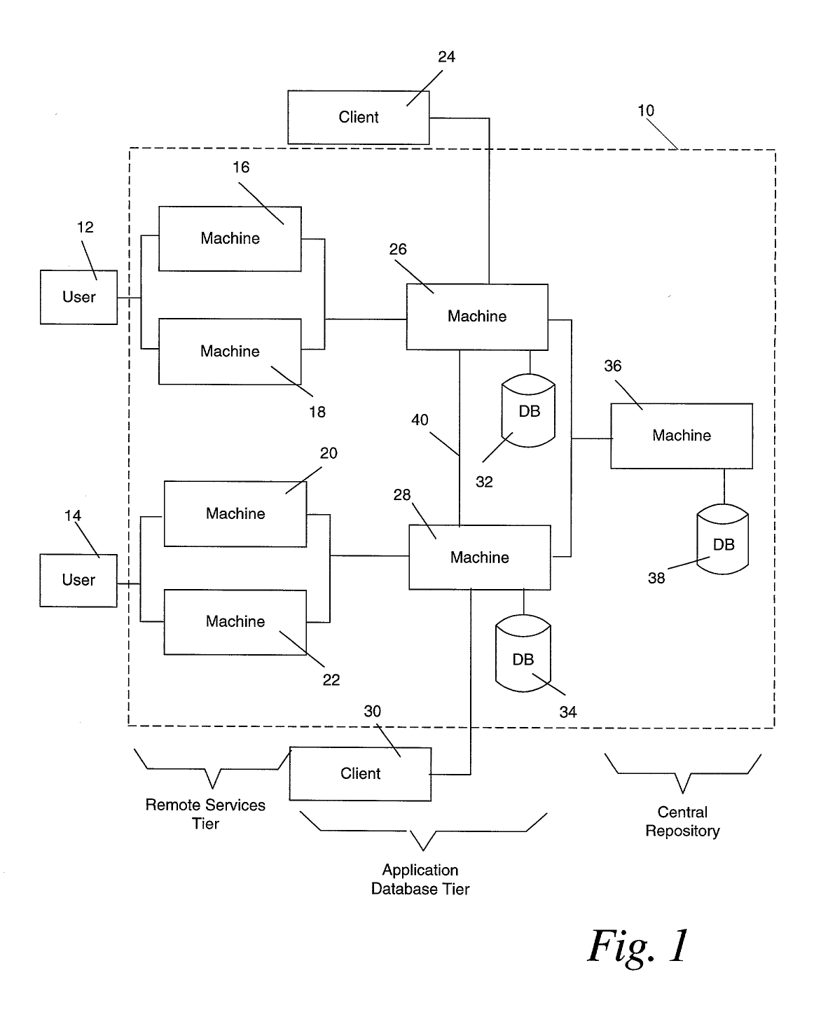

FIG. 1 is a diagram of an example of an automated and distributed replication system 10 for processing electronic transactions. System 10 includes machines 16 and 18 for processing electronic transactions from a user 12, and machines 20 and 22 for processing electronic transactions from a user 14. Users 12 and 14 are each shown connected to two machines for illustrative purposes only; the user would typically interact at a user machine with only one of the machines (16, 18, 20, 22) and would have the capability to be switched over to a different machine if, for example, a machine fails. Users 12 and 14 may interact with system 10 via a browser, client program, or agent program communicating with the system over the Internet or other type of network.

Machines 16 and 18 interact with a machine 26, and machines 20 and 22 interact with a machine 28. Machines 26 and 28 can communicate with each other as shown by connection 40 for processing electronic transactions, and for coordinating and synchronizing the processing. In addition, machine 26 can receive electronic transactions directly from a client 24 representing a client machine or system. Machine 28 can likewise receive electronic transactions directly from a client 30. Clients 24 and 30 may communicate with system 10 over the Internet or other type of network.

Machines 26 and 28 interact with a machine 36, which functions as a central repository. Machines 26 and 28 form an application database tier in system 10, and machines 16, 18, 20 and 22 form a remote services tier in system 10. Each machine can include an associated database for storing information, as shown by databases 32, 34, and 38. System 10 can include more or fewer machines in each of the tiers and central repository for additional load balancing and processing for electronic transactions. The operation and interaction of the various machines can be controlled in part through a properties file, also referred to as an Extensible Markup Language (XML) control file, an example of which is provided in the related provisional application identified above.

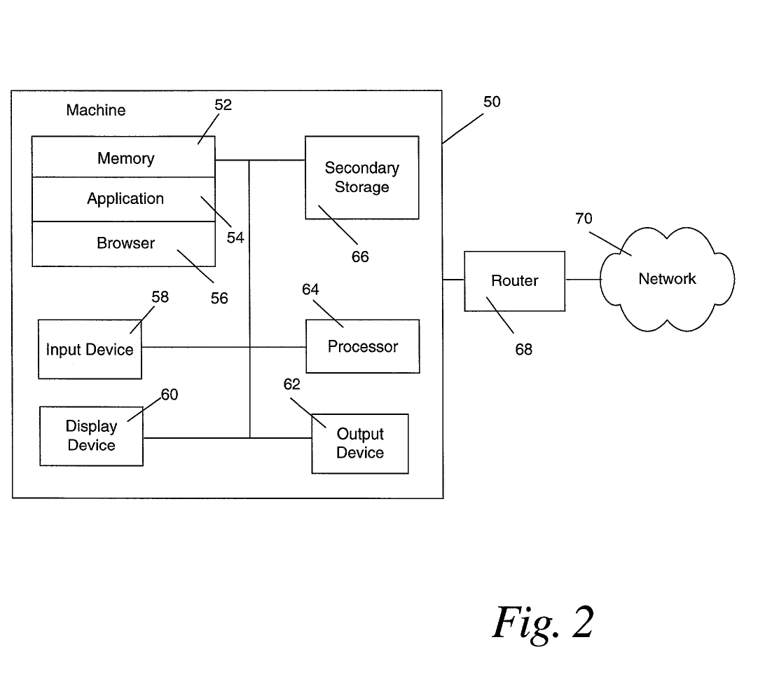

FIG. 2 is a diagram of a machine 50 illustrating exemplary components of the machines shown and referred to in FIG. 1. Machine 50 can include a connection with a network 70 such as the Internet through a router 68. Network 70 represents any type of wireline or wireless network. Machine 50 typically includes a memory 52, a secondary storage device 66, a processor 64, an input device 58, a display device 60, and an output device 62.

Memory 52 may include random access memory (RAM) or similar types of memory, and it may store one or more applications 54 and possibly a web browser 56 for execution by processor 64. Applications 54 may correspond with software modules to perform processing for embodiments of the invention such as, for example, agent or client programs. Secondary storage device 66 may include a hard disk drive, floppy disk drive, CD-ROM drive, or other types of non-volatile data storage. Processor 64 may execute applications or programs stored in memory 52 or secondary storage 66, or received from the Internet or other network 70. Input device 58 may include any device for entering information into machine 50, such as a keyboard, key pad, cursor-control device, touch-screen (possibly with a stylus), or microphone.

Display device 60 may include any type of device for presenting visual information such as, for example, a computer monitor, flat-screen display, or display panel. Output device 62 may include any type of device for presenting a hard copy of information, such as a printer, and other types of output devices include speakers or any device for providing information in audio form. Machine 50 can possibly include multiple input devices, output devices, and display devices. It can also include fewer components or more components, such as additional peripheral devices, than shown depending upon, for example, particular desired or required features of implementations of the present invention.

Router 68 may include any type of router, implemented in hardware, software, or a combination, for routing data packets or other signals. Router 68 can be programmed to route or redirect communications based upon particular events such as, for example, a machine failure or a particular machine load.

Examples of user machines, represented by users 12 and 14, include personal digital assistants (PDAs), Internet appliances, personal computers (including desktop, laptop, notebook, and others), wireline and wireless phones, and any processor-controlled device. The user machines can have, for example, the capability to display screens formatted in pages using browser 56, or client programs, and to communicate via wireline or wireless networks.

Although machine 50 is depicted with various components, one skilled in the art will appreciate that this machine can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). The computer-readable media may include instructions for controlling machine 50 to perform a particular method.

### Caching System Using Timing Queues Based on Last Access Times

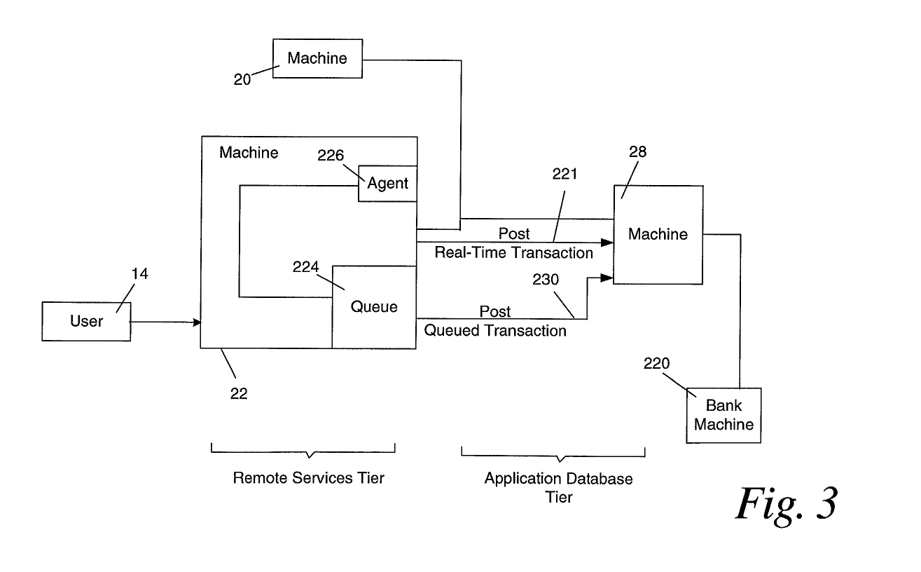

FIG. 3 is a diagram of exemplary components used in a caching system for updating local caches in automated and distributed replication system 10 or other environments. Machines interacting with users, such as machine 22, include an agent program 226 controlling a queue 224 for maintaining and posting electronic transactions. Queued transactions from queue 224 are posted, as illustrated by connection 230, to a receiving machine, in this example a machine in the application database (ADB) tier. Posting a transaction involves transferring to another machine the information embodied in the transaction. A real-time transaction associated with the queued transaction, as illustrated connection 221, can be directly posted to another machine. However, the real-time transaction is effectively ready immediately for posting to a receiving machine without, for example, being “queued up” with other transactions for posting. The system synchronizes and accommodates the posting of transactions in queues and in real-time between the machines in order to maintain current data for processing by, for example, a bank machine 220.

In particular, it synchronizes real-time processes with the asynchronous posting of information from the queue so that the required information is present to execute the real-time processes or other electronic transactions. Queued transactions are held within queue 224 and posted to the receiving machine in, for example, sequential order. As an example, queued transactions can be placed in a first-in-first-out (FIFO) buffer and sequentially posted from the buffer to the receiving machine. Other types of buffering and methodologies for asynchronous posting of information for queued transactions can also be used.

A real-time transaction is typically ready immediately to be posted, meaning it does not necessarily have to wait for posting of other transactions before it can be posted for execution. A queued transaction, therefore, may encounter a delay in posting, as compared with the availability of an associated real-time transaction for posting for execution, since the queued transaction must often wait for posting of other transactions to occur before it is posted. Queue 224 is shown within machine 22 for illustrative purposes only; they can be in the machine or associated with it such as in a related database.

As an example, when a user enters credit card information for a purchase or sales order, that information may be sent as a real-time transaction for immediate execution. However, it cannot be executed until the user's queued transaction(s) corresponding with the credit card information have been posted to the receiving system such as, for example, the application database. In other words, the queued information for the user's request must be posted so that it is available for use in executing the real-time transaction.

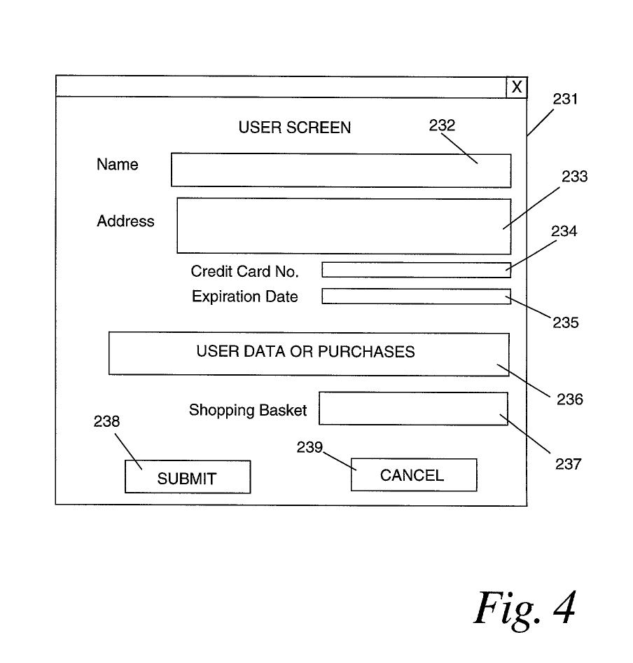

FIG. 4 is an example of a user screen displaying a page 231 for a user to interact with the system to enter examples of information resulting in queued and real-time transactions. Page 231 can be formatted, for example, as a HyperText Markup Language (HTML) page and presented on display device 60 in a user machine by browser 56. Page 231 can include, for example, a name section 232 for entering a user name, an address section 233 for entering a user address, and sections 234 and 235 for entering a credit card number and associated expiration date. The user can enter data or identify on-line purchases in a section 236. Certain transactions, for example, can involve a change in data without including any purchases. A shopping basket section 237 can identify or record total purchases and provide the user with a visual representation of locally stored transaction-related information. The user can submit the entered information by selecting a submit section 238 or cancel the transaction by selecting a cancel section 239. Page 231 is an example of a user page and is provided for illustrative purposes only; a user at machine 14 can enter information through any user screen presenting data.

That user screen can have more or fewer sections, and a different arrangement of sections, than shown in page 231. Also, certain queued and real-time transactions do not necessarily require interaction through a screen or page, and information can be entered in other ways for those transactions.

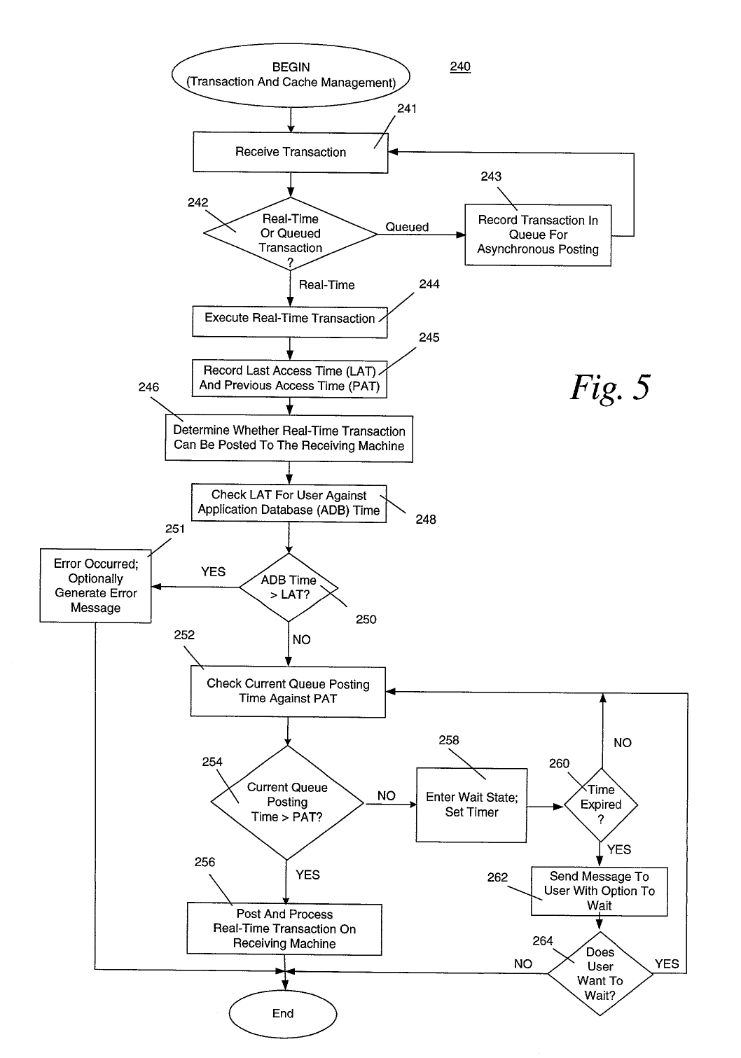

FIG. 5 is a flow chart of a transaction and cache management routine 240 using the exemplary components shown in FIG. 3. Routine 240 can be implemented, for example, in software modules for execution by the corresponding machines. In routine 240, machine 22 receives a transaction (step 241), and it determines whether the transaction is a real-time or a queued transaction (step 242). If it is a queued transaction, machine 22 records the transaction in queue 224 for asynchronous posting (step 243). If it is a real-time transaction, machine 22 executes the transaction (step 244). Machine 22 records the last access time (LAT) and previous access time (PAT) for the cache entry (step 245).

Machine 22 determines if it can post the real-time transaction to the receiving machine (step 246). Machine 22 checks the oldest transaction time for a queued transaction for a user session when a new real-time transaction for the same session needs to access the receiving machine, such as the application database, directly against the application database time for that transaction (step 248). If the application database time is newer than the current transaction time (step 250), machine 22 does not post the real-time transaction, indicating that another user process has updated this transaction after the posting time for it. This indication can result in an error condition and generate an internal error message for the system (step 251).

For the real-time process involving the real-time transaction, machine 22 checks the current posting queue time against the user's previous access time (step 252). If the current queue posting time is newer than the previous access time (step 254), machine 22 posts and processes the real-time transaction on the receiving machine such as, for example, application database machine 28 (step 256).

If the current queue posting time is not newer than the previous access time (step 254), machine 22 can enter a wait state and set a timer (step 258). For the wait state, machine 22 waits for the required information in the queued transaction(s) to propagate from a cache or local memory to the receiving machine for use in processing the real-time transaction. Machine 22 determines if the timer has expired (step 260). It can be programmed for different times depending on, for example, how long the system wants users to wait for the information propagation and transaction processing before providing them with a message. For example, after a user enters a purchase in page 231 and selects the submit section 238, the corresponding queued transaction information must be propagated to the receiving machine, in this example the application database, in order to post the credit card information and charge the credit card account for the purchase.

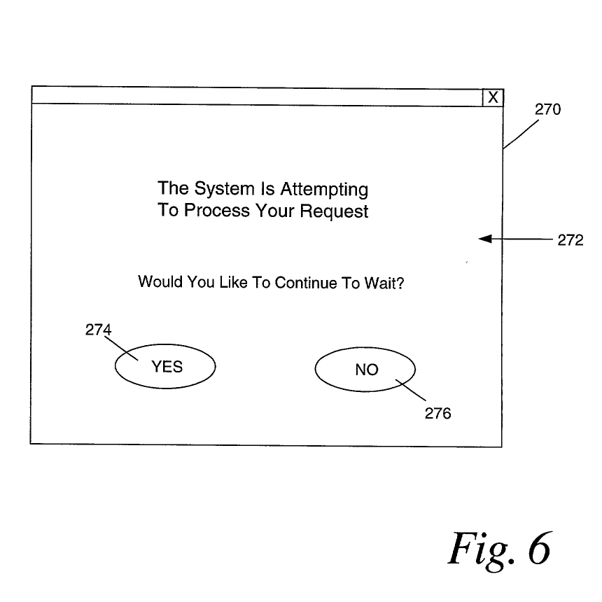

If the timer has expired (step 260), machine 22 can send a message to the user with an option to wait or try the transaction at a later time (step 262). For example, FIG. 6 is a diagram of a page 270 for machine 22 to display overlayed on page 231. Page 270 contains a message 272 requesting whether the user wants to continue to wait for the system to process the request. The user can select a “yes” section 274 to continue to wait or a “no” section 276 to discontinue waiting and try executing the transaction at another time. Wait messages can also be provided in other visual ways or through audio presentations. In addition, users can alternatively enter or predefine how long to wait or how many repeated wait states to endure for a transaction.

Machine 22 determines whether the user wants to continue to wait (step 264) such as, for example, by determining whether the user selects section 274 or 276, or through other entered information, predefined information, or other criteria. If the user wants to continue to wait, machine 22 returns to step 252 to check the current queue posting time again and determine if the information in the queued transaction(s) required for executing the real-time transaction has propagated the receiving machine. Otherwise, if the user does not want to continue to wait, machine 22 terminates the process.

Table 1 provides an example illustrating synchronizing real-time processes with asynchronous posting of queued information from the queue using routine 240. The application database time represents the last access time for any transaction by that user in the receiving machine. The current queue posting time represents the post time of queued transactions and must be greater than the previous access time to post real-time transactions. For example, when the previous access time is 1:00 pm, the system can post real-time transactions when the current queue posting time is 1:01 pm, meaning that it is posting items or transactions recorded at or after 1:01 pm, and that this transaction does not have a dependency that was not posted.

The times shown in Table 1 are provided for illustrative purposes only. Typically, the current queue posting time has temporal closeness to the current time to avoid making a user wait an unnecessarily long time for execution of a real-time transaction.

TABLE 1

| current | |
|---|---|
| time | action |
| 1:00 pm | user enters a queued transaction adding information to a |
| | local memory for a transaction |
| 1:02 pm | user enters information for a real-time transaction, associated |
| | with the queued transaction, and submits the real-time |
| | transaction; real-time transaction is directly attempted |
| | to be posted, once the required queued transaction is posted |
| 1:05 pm | user submits queued transaction; |
| | queued transaction goes into queue for asynchronous |
| | transmission |
| 1:05 pm | current queue posting time is 1:03 pm; |
| | queued transactions entered at 1:03 pm are being posted; |
| | user's queued transaction has not yet been transmitted to |
| | the ADB |
| 1:06 pm | current queue posting time is 1:04 pm; |
| | user still waiting |
| 1:07 pm | current queue posting time is 1:05 pm; |
| | user's queued transaction now sent to the ADB; |
| | user's real-time transaction can now be posted and executed |

While the present invention has been described in connection with an exemplary embodiment, it will be understood that many modifications will be readily apparent to those skilled in the art, and this application is intended to cover any adaptations or variations thereof. For example, different labels for the various modules and databases, and various hardware embodiments for the machines, may be used without departing from the scope of the invention. This invention should be limited only by the claims and equivalents thereof.

1. A method for caching data using timing queues based upon access to the data, comprising:
receiving a queued transaction;
storing the queued transaction in a queue for asynchronous posting;
receiving a real-time transaction for execution based upon the queued transaction;
detecting an indication of whether the queued transaction has been posted; and
executing the real-time transaction based upon the detecting.

2. The method of claim 1, further including receiving a time related to storing of the queued transaction in the queue for the posting.

3. The method of claim 2 wherein the detecting step includes comparing the time with an indication of current posting from the queue.

4. The method of claim 1 wherein the receiving the queued transaction step includes receiving an order.

5. The method of claim 1, further including entering a wait state based upon the detecting.

6. The method of claim 5, further including terminating the wait state based upon a time parameter.

7. The method of claim 5, further including querying the user for use in determining whether to terminate the wait state.

8. A method for caching data using timing queues based upon access to the data, comprising:
receiving a real-time transaction from a user;
storing information for the real-time transaction in a local cache for posting;
recording for the stored information an associated last access time and a previous access time;
detecting an application database time and a current queue posting time;
comparing the last access time with the application database time and comparing the previous access time with the current queue posting time; and
selectively posting and executing the real-time transaction based upon the comparing.

9. The method of claim 8, further including terminating the real-time transaction if the application database time is greater than the last access time.

10. The method of claim 8, further including executing the real-time transaction if the current queue posting time is greater than the previous access time.

11. An apparatus for caching data using timing queues based upon access to the data, comprising:
a receive module for receiving a queued transaction;
a store module for storing the queued transaction in a queue for asynchronous posting;
a transaction module for receiving a real-time transaction for execution based upon the queued transaction;
a detect module for detecting an indication of whether the queued transaction has been posted; and
an execute module for executing the real-time transaction based upon the detecting.

12. The apparatus of claim 11, further including a module for receiving a time related to storing of the queued transaction in the queue for the posting.

13. The apparatus of claim 12 wherein the detect module includes a module for comparing the time with an indication of current posting from the queue.

14. The apparatus of claim 11 wherein the receive module includes a module for receiving an order.

15. The apparatus of claim 11, further including a module for entering a wait state based upon the detecting.

16. The apparatus of claim 15, further including a module for terminating the wait state based upon a time parameter.

17. The apparatus of claim 15, further including a module for querying the user for use in determining whether to terminate the wait state.

18. An apparatus for caching data using timing queues based upon access to the data, comprising:
a receive module for receiving a real-time transaction from a user;
a store module for storing information for the real-time transaction in a local cache for posting;
a record module for recording for the stored information an associated last access time and a previous access time;
a detect module for detecting an application database time and a current queue posting time;
a compare module for comparing the last access time with the application database time and comparing the previous access time with the current queue posting time; and
an execute module for selectively posting and executing the real-time transaction based upon the comparing.

19. The apparatus of claim 18, further including a module for terminating the real-time transaction if the application database time is greater than the last access time.

20. The apparatus of claim 18, further including a module for executing the real-time transaction if the current queue posting time is greater than the previous access time.
